(19) United States
(12) Patent Application Publication
(10) Pub. No.: US 2016/0152739 A1
(43) Pub. Date: Jun. 2, 2016

(54) ISOCYANATE/SILOXANE POLYETHER COMPOSITION

(71) Applicant: EVONIK DEGUSSA GMBH, Essen (DE)

(72) Inventors: Christian EILBRACHT, Herne (DE); Carsten SCHILLER, Ratingen (DE); Martin GLOS, Borken (DE)

(73) Assignee: EVONIK DEGUSSA GMBH, Essen (DE)

(21) Appl. No.: 14/898,575

(22) PCT Filed: May 26, 2014
(86) PCT No.: PCT/EP2014/060785

§ 371 Date: Dec. 15, 2015

(30) Foreign Application Priority Data
Jun. 18, 2013 (DE) 10 2013 211 349.8

(51) Int. Cl. C08F 8/30; C08J 9/14; C08J 9/00

(52) U.S. Cl. CPC C08F 8/30; C08J 9/0061; C08J 9/142; C08J 9/144; C08J 2375/04; C08J 2429/10

(57) ABSTRACT

The present invention is directed to a composition comprising a siloxane of the formula (I) having at least one polyether radical which is linked via a urethane bond to an organic radical, preferably to an organic radical which has one or more isocyanate groups and/or polyurethane bonds, and one or more compounds which have two or more isocyanate groups, characterized in that the composition comprises no polyols which contain no silicon, or reaction products thereof with isocyanates; to use of the composition for producing polyurethanes and polyurethane foams; and to polyurethanes and polyurethane foams produced accordingly; and to their use.

The present invention relates to a composition comprising a siloxane of the formula (I) having at least one polyether radical which is linked via a urethane bond to an organic radical, preferably to an organic radical which has one or more isocyanate groups or polyurethane bonds, and one or more compounds which have two or more isocyanate groups, which is characterized in that the composition comprises no polyols which contain no silicon, or reaction products thereof with isocyanates, and also to the use of the composition for producing polyurethanes and polyurethane foams, and also to polyurethanes and polyurethane foams produced accordingly and to their use.

### PRIOR ART

WO 2009/003165 describes mixtures of innovative blowing agents which must be provided with specific additives in order to counteract a damaging effect of the blowing agent decomposition products on the siloxane surfactants used.

US 2009/0099273 describes the use of Si-free surfactants in order to avoid the problem with the reaction products formed from amine and fluorine-containing blowing agents. There is, however, only a restricted number of surfactants available.

Both alternatives imply a substantial restriction in the production of PU foam. There is therefore a need for siloxanes which do not have above-described drawbacks and are suitably useful as silicone surfactants in the production of PU foam, irrespective of the blowing agent employed.

DE 10 2008 054 774, WO 2009/130194 and WO 2011/113708 describe the production of (flame-retardant) polyurethane foams using siloxanes which carry—NH—C(O)— groups and free OH groups and have been obtained by reaction of siloxanes containing OH groups, more particularly siloxanes having hydroxymethyl radicals or hydroxymethyl ether radicals, with isocyanates.

U.S. Pat. No. 3,957,843 describes the preparation of polyether siloxanes, where the polyethers may also not carry any OH group on the end, but may instead be reacted with—among other reactants—monofunctional isocyanates.

DE 2558523 describes branched polysiloxane-polyalkylene copolymers and their use as a PU foam stabilizer. In this case the branching is generated by reaction of organosiloxanes with polyisocyanates, and all the isocyanate functions are subsequently reacted with monofunctional polyethers.

An object of the present invention was to provide a process for producing polyurethane foam where damage to the foam stabilizers (siloxane surfactants) by blowing agents and their degradation products can be avoided.

Surprisingly it has now been found that compounds of the formula (I) and compositions comprising compounds which have two or more isocyanate functions and compounds of the formula (I) achieve this object.

This was surprising in so far as documents U.S. Pat. No. 3,957,843 and DE 2558523 provide no indication whatsoever that the siloxanes described therein are more resistant to the decomposition triggered by damaging compounds resulting from the blowing agents (or from other components).

The present invention accordingly provides compositions comprising a siloxane of the formula (I) as defined below, with the proviso that there is at least one radical of the formula (II), and one or more compounds which have two or more isocyanate groups, characterized in that the composition comprises no polyols which contain no silicon, or reaction products thereof with isocyanates.

Likewise provided by the present invention are a process for producing polyurethane foams, characterized in that the composition of the invention is used, and also the polyurethane foams produced by this process, and their use in and/or as refrigerator insulation, insulation panels, sandwich elements, pipe insulations, spray foam, 1 and/or 1.5 component can foam, imitation wood, modelling foam, packaging foam, mattress, furniture cushioning, automotive seat cushioning, headrest, dashboard, automotive interior trim, automotive roof liner, sound absorption material, steering wheel, footwear sole, carpet backing foam, filter foam, sealing foam and adhesive or for producing corresponding products.

An advantage of the composition of the invention is that the siloxane of the formula (I) used as foam stabilizer has a virtually unlimited shelf life. Damage by blowing agents or any other components used in producing a PU foam, or their successor products, cannot take place, since the foam stabilizer comes into contact with the blowing agent only during the actual production of the foam.

“Virtually unlimited shelf life” means, in the context of the present invention, that a composition of the invention is storage-stable for preferably at least 3 months, in the sense that after the storage period there are no changes apparent in the foaming procedure in comparison to freshly prepared compositions. In this context it should be noted that the storage conditions are selected in accordance with an isocyanate; in other words, for example, the composition is not subject to high temperatures (greater than 50° C.) or to water in the form of atmospheric moisture (greater than 50 mg/kg of composition per week). Such instructions on the handling and storage of isocyanates can be found in information material from the isocyanate manufacturers, such as BASF's MDI Handbook, for example.

In addition to their good shelf life, the compositions of the invention also feature a particularly simple form of processing, since the composition can be added directly as isocyanate component in the production procedure.

The process of the invention has the advantage that in possibly preformulated mixtures of polyols and/or catalysts, water/blowing agents and optionally further additives, which are marketed as ready-to-use polyurethane foam systems, the chemicals present may include some which would damage a siloxane. Consequently, corresponding problems with deterioration in foam properties as a result of long storage periods for such systems are avoided.

The process of the invention and the composition of the invention have the advantage in particular that they can be used in two-component foaming methods in which halogenated olefins and/or formic acid blowing agents are used and with which polyurethane foams can be obtained that are notable for good insulating properties and closed-cell content.

In one-component systems, the problem of siloxane degradation typically does not arise, since such systems use milder catalysts and/or different blowing agents. For example, a one-component system contains no water. Nevertheless, it may be advantageous to use the composition of the invention here as well, to produce the one-component system, in order to improve the foam properties (in terms of foam yield, fine-cell content and open-cell content).

An advantage of the polyurethane foam of the invention is that it exhibits consistently high quality, i.e. a particularly fine cell structure with particularly few foam defects (voids, cracks, densifications).

The various subject matter of the invention is described by way of example below, without any intention that the invention should be confined to these exemplary embodiments. Ranges, general formulae or classes of compound indicated hereinafter are intended to encompass not only the corresponding ranges or groups of compounds that are explicitly referred to, but instead also to encompass all sub-ranges and sub-groups of compounds that may be obtained by extraction of individual values (ranges) or compounds. Where the present description cites documents, the intention is that the content of any such document, particularly in respect of the factual context in which the document has been cited, should belong completely to the disclosure content of the present invention. Any percentages, unless otherwise specified, are figures in weight percent. Any averages reported below are, unless otherwise specified, weight averages. Any parameters specified below and obtained by measurement have been measured, unless otherwise specified, at a temperature of 25° C. under a pressure of 101,325 Pa.

Polyurethane foam (PU foam) in the context of the present invention is foam obtained as a reaction product based on isocyanates and polyols and/or compounds having isocyanate-reactive groups. Here, as well as the eponymous polyurethane, there may also be further functional groups formed, such as allophanates, biurets, ureas or isocyanurates, for example. In the sense of the present invention, accordingly, PU foams comprehend not only polyurethane foams (PUR foams) but also polyisocyanurate foams (PIR foams). Preferred polyurethane foams are rigid polyurethane foams.

The composition of the invention, comprising a siloxane of the formula (I)

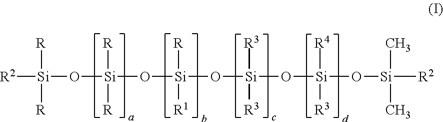

in which
R³=

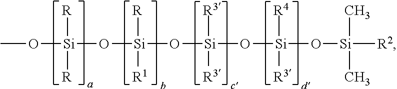

a independently at each occurrence is 0 to 500, preferably 1 to 300 and more particularly 2 to 150,
b independently at each occurrence is 0 to 60, preferably 1 to 50 and more particularly 1 to 30,
c independently at each occurrence is 0 to 10, preferably 0 or >0 to 5,
d independently at each occurrence is 0 to 10, preferably 0 or >0 to 5,
c′ independently at each occurrence is 0 to 10, preferably 0 or >0 to 5,
d′ independently at each occurrence is 0 to 10, preferably 0 or >0 to 5,
   with the proviso that per molecule of the formula (I) the average number Σd+d′ with R^{3′}═R³ of the T units and the average number Σc+c′ with R^{3′}═R³ of the Q units per molecule is in each case not greater than 50, the average number Σa of the D units per molecule is not greater than 2000 and the average number Σb of the R¹ carrying siloxy units per molecule is not greater than 100,
R independently at each occurrence is at least one radical from the group of linear, cyclic or branched, aliphatic or aromatic, saturated or unsaturated hydrocarbon radicals having 1 up to 20 C atoms, preferably a methyl radical,
R² independently at each occurrence is R¹ or R,
R^{3′} independently at each occurrence is R³ or R,
R¹ is different from R and independently at each occurrence is an organic radical and/or a radical selected from the group encompassing
   —CH₂—CH₂—CH₂—O—(CH₂—CH₂O—)ₓ—(CH₂—CH(R′)O—)_{y}—R″
   —CH₂—CH₂—O—(CH₂—CH₂O—)ₓ—(CH₂—CH(R′)O—)_{y}—R″
   —CH₂—R^{IV}
   —CH₂—CH₂—(O)_{x″}—R^{IV}
   —CH₂—CH₂—CH₂—O—CH₂—CH(OR″)—CH₂OR″

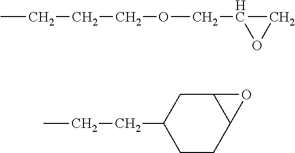

or
—CH₂—CH₂—CH₂—O—CH₂—C(CH₂OR″)₂—CH₂—CH₃, R¹ preferably being
—CH₂—CH₂—CH₂—O—(CH₂—CH₂O—)ₓ—(CH₂—CH(R′)O—)_{y}—R″ and/or
—CH₂—CH₂—O—(CH₂—CH₂O—)ₓ—(CH₂—CH(R′)O—)_{y}—R″ and/or
—CH₂—R^{IV},
in which
x is 0 to 100, preferably >0, more particularly 1 to 50,
x′ is 0 or 1,
y is 0 to 100, preferably >0, more particularly 1 to 50,
x preferably being 0 to 100, more preferably 1 to 80, preferably 2 to 50 and y being 0 to 100, more preferably 0 or 1 to 80, preferably 0 or 2 to 50,
preferably with the proviso that x+y is greater than or equal to 1, more preferably greater than or equal to 2, preferably greater than or equal to 3, and very preferably greater than or equal to 4,
R′ independently at each occurrence is an optionally substituted alkyl or aryl group having 1 to 12 C atoms, substituted for example by alkyl radicals, aryl radicals or haloalkyl or haloaryl radicals, it being possible for substituents R′ different among one another to be present within a radical R¹ and/or within a molecule of the formula I, R′ preferably being methyl, ethyl and/or phenyl radicals, more preferably methyl radicals, and
R″ independently at each occurrence is a hydrogen radical or an alkyl group having 1 to 4 C atoms, preferably a methyl group, a group —C(O)—R′″ with R″=alkyl radical, a group —CH₂—O—R′, an alkylaryl group, such as a benzyl group, for example, the group —C(O)NH—R′ or a radical of the formula (II)

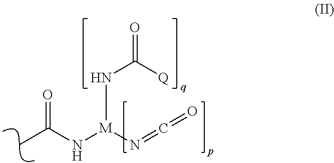

with M=organic radical, preferably organic radical containing exclusively hydrogen and carbon and optionally halogen atoms, having at least 5, preferably from 5 to 50, more preferably from 6 to 35 carbon atoms,
p=0 or 1 to 15, preferably 1 to 5, more preferably 1, 2, 3, 4 or 5,
q=0 or 1 to 15, preferably 0 or 1 to 5, more preferably 0,
sum total p+q is greater than or equal to 1, preferably 1 to 30, more preferably 1 to 10 and very preferably 1, 2, 3, 4 or 5,
Q=organic radical or identical or different radical of the formula (I) attached in turn via the radical R¹, preferably organic radical containing no silicon atom or identical radical of the formula (I) (Q, therefore, is linked two or more times to the same siloxane of the formula (I)), and more preferably organic radical containing no silicon atom, with the proviso that in a compound of the formula (I), irrespective of the number of possible radicals of the formula (I), the number of silicon atoms in the compound is preferably not more than 1500, more preferably 500 and very preferably not more than 300,
R^{IV} is a linear, cyclic or branched, optionally substituted hydrocarbon radical, substituted for example by halogens, having 1 to 50, preferably 9 to 45, more preferably 13 to 37 C atoms,
R⁴ independently at each occurrence may be R, R¹ and/or a heteroatom-substituted, functionalized, organic, saturated or unsaturated radical selected from the group of alkyl, aryl, chloroalkyl, chloroaryl, fluoroalkyl, cyanoalkyl, acryloyloxyaryl, acryloyloxyalkyl, methacryloyloxyalkyl, methacryloyloxypropyl or vinyl radical, with the proviso that there is at least one radical of the formula (II) in a compound of the formula (I),
and one or more compounds having two or more isocyanate groups (VICG), is notable for the fact that the composition comprises no polyols which contain no silicon atom, or reaction products thereof with isocyanates, and preferably no amines which have no silicon atoms. Preferably at least 10% (numerically) of the radicals R″ are of the formula (II), and more preferably no radical R″ is a hydrogen radical.

The various monomer units of the building blocks indicated in the formulae (siloxane chains and/or polyoxyalkylene chain) may be of blockwise construction with one another, with an arbitrary number of blocks and an arbitrary sequence, or subject to a statistical distribution. The indices used in the formulae should be viewed as statistical average values.

Radicals of the formula (II) present in the siloxanes of the formula (I) may be, for example, the radicals set out below, with NCO representing the group —N═C═O:

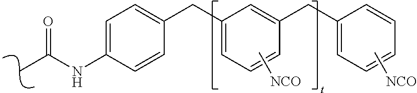

with t=0 to 5

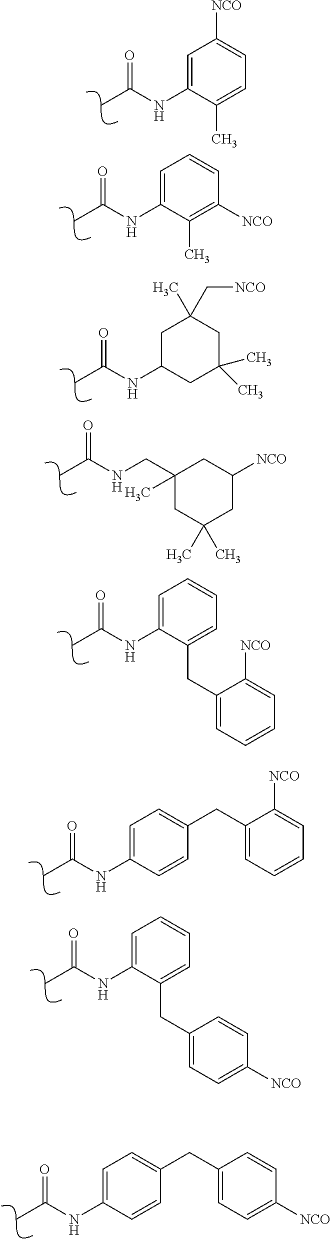

It may be advantageous if said siloxane of the formula (I) in the composition of the invention is a siloxane in which q=0 in all of the radicals of the formula (II). Siloxane of the formula (I) preferably comprises exclusively siloxanes in which q=0 in all of the radicals of the formula (II).

Depending on intended use, it may be advantageous if the composition of the invention comprises, as siloxanes of the formula (I), those, preferably as siloxane of the formula (I) exclusively those, which have no branching or on average less than one branching point in the siloxane framework, and for which, therefore, Σc+Σd<1 and Σc′+Σd′=0, and preferably c and d=0. A composition of the invention of this kind is especially advantageous when the intention is to produce a relatively closed-cell polyurethane foam. It may, however, also be advantageous for the composition of the invention to comprise as siloxane of the formula (I) a siloxane, or preferably exclusively those siloxanes, for which on average there is one or more than one branching site present in the siloxane framework and for which, therefore, Σc+Σc′+Σd+Σd′ 1. A composition of the invention of this kind is especially advantageous when the intention is to produce a fairly open-cell polyurethane foam. The composition of the invention preferably comprises siloxanes of the formula (I) in which a independently at each occurrence is 1 to 300, b independently at each occurrence is 1 to 50, c+c′ independently at each occurrence is 0 to 4, d+d′ independently at each occurrence is >0 to 4, with the proviso that per molecule of the formula (I) the average number Σd+d′ of the T units and the average number Σc+c′ of the Q units per molecule is in each case not greater than 20, the average number Σa of the D units per molecule is not greater than 1500 and the average number Σb of the R¹ carrying siloxy units per molecule is not greater than 50.

The siloxane of the formula (I) present in the composition of the invention is more preferably a siloxane for which c and d=0. Preferred compositions of the invention comprise exclusively siloxanes of the formula (I) for which c and d=0.

It may be advantageous for the siloxane of the formula (I) present in the composition of the invention to comprise a siloxane in which the radicals which carry radicals of the formula (II) are exclusively in comb positions. The composition of the invention preferably comprises exclusively siloxanes of the formula (I) for which the radicals which carry the radicals of the formula (II) are in comb position.

Depending on the intended use, however, it may also be advantageous if the composition comprises siloxanes of the formula (I) of the invention in which the terminal positions, also called alpha and omega (the radicals R²), on the siloxane are at least in part radicals R¹, i.e. R²═R¹. In this case at least 10 mol %, preferably at least 30 mol %, more preferably at least 50 mol % of the terminal positions are functionalized with radicals R¹. With particular preference at least 25% of the radicals R¹ (numerically, based on the number of radicals R¹) are those which have a radical of the formula (II).

The composition of the invention preferably comprises, as siloxane of the formula (I), siloxanes for which the ratio a/b is at least 7, preferably greater than 10, more preferably greater than 12. The composition of the invention preferably comprises, as siloxane of the formula (I), exclusively siloxanes for which the ratio a/b is at least 7, preferably greater than 10, more preferably greater than 12. In the case of these siloxanes of the formula (I), the radical R is preferably in each case a methyl radical.

Preferred siloxanes of the formula (I) in the compositions of the invention are those for which oxyalkylene units present in the radical R¹ are exclusively oxyethylene units. The composition of the invention preferably comprises, as siloxane of the formula (I), exclusively siloxanes for which the oxyalkylene units present in the radical R¹ are exclusively oxyethylene units.

Siloxanes of the formula (I) that are present in the composition of the invention are preferably siloxanes in which R¹ independently at each occurrence is an organic radical selected from the group encompassing —CH₂—CH₂—CH₂—O—(CH₂—CH₂O—)ₓ—(CH₂—CH(R′)O—)_{y}—R″ and/or —CH₂—CH₂—O—(CH₂—CH₂O—)ₓ—(CH₂—CH(R′)O—)_{y}—R″ and/or —CH₂—R′, in which x is 0 to 100, preferably >0, more particularly 1 to 50, y is 0 to 100, preferably >0, more particularly 1 to 50, R′ is methyl and R″ independently at each occurrence is a group of the formula (II) or an alkyl group having 1 to 4 C atoms, a group —C(O)—R′″ with R′″=alkyl radical, a group —CH₂—O—R, an alkylaryl group, such as a benzyl group, for example, or the group —C(O)NH—R′, with the proviso that at least 10% (numerically) of the groups R″ are formula (II), with the molar fraction of oxyethylene units preferably being at least 70% of the oxyalkylene units, i.e. x/(x+y)>0.7. It may be advantageous, moreover, if the polyoxyalkylene chain carries a group of the formula (II) at the end and at the same time the molar fraction of oxyethylene units makes up not more than 70% of the oxyalkylene units, i.e. x/(x+y)<0.7 and R″ is a group of the formula (II).

It may be advantageous if siloxanes of the formula (I) present in the composition of the invention include those in which at least 10 mol % of the radicals R¹, preferably at least mol %, more preferably at least 40 mol % conform to the formula —CH₂—R^{IV}, with R^{IV} being a linear or branched hydrocarbon having 9 to 17 carbon atoms.

For the siloxanes of the formula (I) that are present in the composition of the invention, the fraction of the sum total of the radicals R¹ is not less than 40 wt %, preferably not less than 45 wt %, more preferably not less than 50 wt %, based on the total molar weight of the siloxane.

Siloxanes of the formula (I) present preferably in the composition of the invention are those for which none of the radicals R″ is a hydrogen.

Siloxanes of the formula (I) present in the composition of the invention are more preferably those in which none of the radicals R″ is a hydrogen and in which the oxyalkylene units present in radical R′ are exclusively oxyethylene units.

The fraction of radicals R¹ which have at least one radical of the formula (II), based on the sum total of the radicals R¹, is preferably at least 20%, more preferably at least 40% and very preferably at least 60% (numerical percentages).

The compositions of the invention may be present as a result of the production procedure or else may be produced subsequently, in order, for example, to facilitate the meterability of the siloxanes of the formula (I) or else to improve the ease of incorporation of the siloxanes of the formula (I) into the reaction mixture to be foamed.

The compounds (VICG), having two or more isocyanate groups are preferably selected from the isocyanates or polyisocyanates or mixtures thereof. Preferred VICG are aromatic polyfunctional isocyanates, of the kind also used in the foaming procedures. Particularly preferred VICG isocyanates are selected in particular from 4,4′-diphenylmethane diisocyanate (MDI), toluene diisocyanate (TDI), hexamethylene diisocyanate (HMDI) and isophorone diisocyanate (IPDI). Particularly suitable is the mixture, known as “polymeric MDI” (“crude MDI”), of MDI and more highly condensed analogues having an average functionality of 2 to 4, and also the various isomers of TDI in pure form or as an isomer mixture. With particular preference, the compounds (VICG), the isocyanates used as isocyanate component for the foaming procedure, and the isocyanates used for preparing the compounds of the formula (I) are identical or, in the case of mixtures, of identical composition.

In the composition of the invention the ratio by mass of siloxanes of the formula (I) to VICG is preferably from 1:500 to 1:10, more preferably from 1:300 to 1:20.

Besides the stated compounds, the compositions of the invention may comprise further substances. Such substances ought to have sufficiently low reactivity or no reactivity with respect to the isocyanate functions of the siloxanes. Suitable substances may be, for example, aliphatic or aromatic hydrocarbons such as Solvesso® products, xylene, Solvesso® A, Solvesso® 100, Solvesso® 150, Hyblene®, triglycerides, esters such as butyl acetate, isopropyl myristate, ethylhexyl stearate, decyl oleate, isocetyl palmitate, PEG 400 dicocoate, amides such as N-alkylpyrrolidones or N,N-dimethyldecanamide, glymes, i.e. glycol diethers, such as monoethylene glycol dimethyl ether (monoglyme), allyl polyglycol methyl ether, polyglycol diallyl ether, diethylene glycol dimethyl ether (diglyme), triethylene glycol dimethyl ether (triglyme), tetraethylene glycol dimethyl ether (tetraglyme), polyethylene glycol dimethyl ether, diethylene glycol dibutyl ether, polyethylene glycol dibutyl ether and dipropylene glycol dimethyl ether, for example.

In the composition of the invention, the ratio by mass of these further substances to siloxanes of the formula (I) is preferably from 100:1 to 1:100, more preferably from 10:1 to 1:10.

The siloxanes of formula (I) may be prepared by the known methods, such as by the noble metal-catalysed hydrosilylation reaction of compounds containing a double bond and optionally an OH group with corresponding hydrogensiloxanes as described in EP 1 520 870, for example, and subsequent reaction of the siloxanes prepared in this way, modified with radicals containing an OH group, with suitable isocyanates. Specification EP 1 520 870 is hereby introduced as a reference and is considered part of the disclosure content of the present invention.

If the siloxanes of the formula (I) are to have a fraction of the radicals R¹ that are hydrocarbon radicals, they may be obtained, for example, by using a corresponding fraction of olefins in the hydrosilylation.

As compounds which have at least one double bond per molecule it is possible to make use, for example, of α-olefins, vinylpolyoxyalkylenes and/or allylpolyoxyalkylenes. Preference is given to using vinylpolyoxyalkylenes and/or allylpolyoxyalkylenes. Particularly preferred vinylpolyoxyalkylenes are, for example, vinylpolyoxyalkylenes having a molar weight in the range from 100 g/mol to 5000 g/mol, which may be synthesized from the monomers propylene oxide, ethylene oxide, butylene oxide and/or styrene oxide in blockwise or random distribution and which may be not only hydroxy-functional but also endcapped by a methyl ether function or an acetoxy function. Examples of particularly preferred allylpolyoxyalkylenes are allylpolyoxyalkylenes having a molar weight in the range from 100 g/mol to 5000 g/mol, which may be synthesized from the monomers propylene oxide, ethylene oxide, butylene oxide and/or styrene oxide, blockwise or in random distribution, and which may be not only hydroxy-functional but also endcapped by methyl ether function or an acetoxy function. Particularly preferred compounds which have at least one double bond per molecule are, as specified in the examples, α-olefins, allyl alcohol, 1-hexenol, vinylpolyoxyalkylenes and/or allylpolyoxyalkylenes, and also allyl glycidyl ether and vinylcyclohexene oxide. It should be noted here that for the isocyanate derivatization it is necessary to use at least one compound, having an OH group and a double bond, which can then be reacted with a multiunctional isocyanate (MFI) in order to allow the structural element of the formulae (II) to be obtained. Preferably at least 10% (numerically), more preferably at least 20%, very preferably at least 40% and especially preferably at least 60% of the polyether side chains carry an OH function which is subsequently reacted with an isocyanate. In one preferred embodiment of the invention, 10% to 90%, more preferably 20%-80%, especially preferably 30% to 70% of the polyether side chains carry an OH function which is subsequently reacted with an isocyanate, and the remaining polyether side chains carry alkyl or acetyl end groups, more particularly methyl groups.

The preparation of the structural elements of the formula (II) (derivatization) is accomplished preferably by reaction of the radicals which carry OH functions, more particularly polyether radicals, of the siloxane with the multiply functional isocyanates in accordance with the known methods for preparing urethanes from isocyanates and alcohols. In this procedure it is preferred to use sufficient MFI for there to be a molar excess of isocyanate groups relative to the OH groups. This is preferred especially when difunctional diisocyanates such as TDI, for example, are being used for the derivatization.

In the course of the derivatization, preferably, the siloxane carrying OH functions is metered into the isocyanate.

The effect of the excess and of the metering method is that there is always an NCO function of the parent isocyanate retained, and the siloxanes, as shown in formula 1, carry an NCO functionality.

The derivatization is preferably carried out under mild conditions (temperatures less than 80° C., preferably less than 60° C., and atmospheric pressure) in the absence of moisture. Catalysts suitable for the polyurethane reaction may be used, although it should be ensured that catalysts are avoided if they lead to secondary reactions such as trimerization of the isocyanates, for example, and so impair the stability of the mixture in storage. For this reason, derivatization takes place preferably without addition of catalysts.

MFIs that can be used include, for example, aliphatic or aromatic isocyanates. Suitable isocyanates in the sense of this invention are all multifunctional organic isocyanates, such as, for example, 4,4′-diphenylmethane diisocyanate (MDI), toluene diisocyanate (TDI), naphthalene diisocyanate (NDI), tris(4-isocyanatophenyl)methane, m-tetramethylxylylene diisocyanate (TMXDI), 1,1-methylenebis(4-isocyanatocyclohexane) (H12-MDI), hexamethylene diisocyanate (HMDI) and more highly functional isocyanates based thereon, such as biuret triisocyanates or isocyanurate-containing oligomers, and also isophorone diisocyanate (IPDI) and corresponding isocyanates of higher functionality that are based thereon. Particularly suitable is the mixture, known as “polymeric MDI” (“crude MDI”) of MDI and more highly condensed analogues with an average functionality of 2 to 4, and also the various isomers of TDI in pure form or as an isomer mixture. Furthermore, M may also comprise carbodiimide, uretonimine, uretdione, isocyanurate, allophanate, biuret, carbamate or other functionalities which can be prepared from isocyanates.

In one preferred embodiment of the invention a polymeric MDI is used as MFI for the derivatization of the siloxane. This polymeric MDI is preferably a mixture of bicyclic, tricyclic and higher polycyclic MDI components. Such mixtures may also be used in the foaming procedure. Examples of materials available commercially are as follows: Desmodur® 44v20 and Desmodur® 44V70 from Bayer Material Science, Suprasec® 5025 from Huntsman or Lupranat® M20, Lupranat® M70L from BASF.

Using these MFI compounds it is possible, for example, to obtain radicals of the formula (II) which satisfy the following formula:

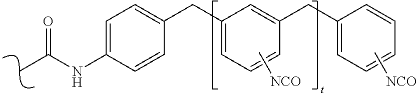

with t=0 to 5

Through the use of tolyl diisocyanate (TDI) for the derivatization it is possible to obtain radicals of the formula (II) having the following structural formulae:

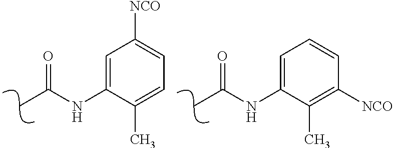

Through the use of isophorone diisocyanate for the derivatization it is possible to obtain radicals of the formula (II) having the following structural formulae:

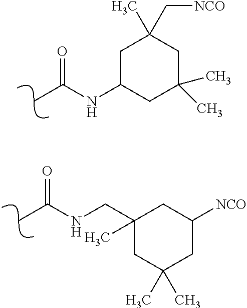

Through the use of monomeric methylenediphenyl diisocyanate (MDI) for the derivatization it is possible, depending on the nature of the MDI isomers with functionalization in positions 4,4′-, 2,4′- or 2,2′- to obtain the radicals of the formula (II) having the following structural formulae:

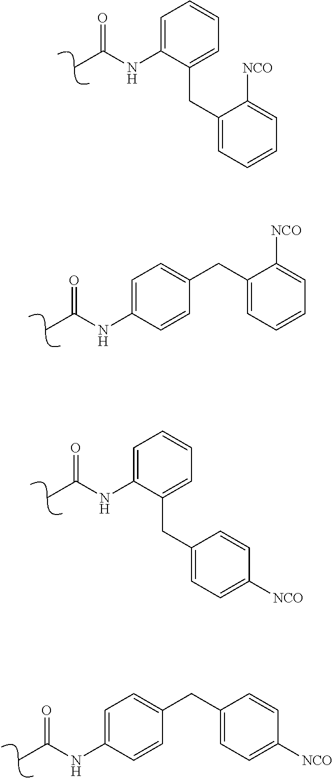

The compositions of the invention may be used, for example, for producing polyurethane foams. The compositions of the invention are preferably used in the process of the invention, more particularly for producing polyurethane foams of the invention.

A feature of the process of the invention for producing polyurethane foam is that a composition of the invention is used.

The amount of composition used is preferably such that the mass fraction of compounds of the formula (I) in the completed polyurethane foam is from 0.01 to 10 wt %, preferably from 0.1 to 3 wt %.

The compositions of the invention may be used, for example, as foam stabilizers in the customary formulations for the production of polyurethane foam materials. Customary formulations preferably feature one or more organic isocyanates having two or more isocyanate functions, one or more polyols having two or more isocyanate-reactive groups, catalysts for the isocyanate-polyol and/or isocyanate-water and/or the isocyanate trimerization reactions, water, optionally physical blowing agents, optionally flame retardants and optionally further additives.

Preferred additives/auxiliaries are preferably selected from organic (Si-free) foam stabilizers, surfactants, nucleating agents, cell-refining additives, cell-opening agents, crosslinkers, emulsifiers, flame retardants, antioxidants, antistats, biocides, colour pastes, solid fillers, amine catalysts, metal catalysts, polyols and/or buffers.

Suitable isocyanates for use in the formulation are all multifunctional organic isocyanates, examples being 4,4′-diphenylmethane diisocyanate (MDI), toluene diisocyanate (TDI), hexamethylene diisocyanate (HMDI) and isophorone diisocyanate (IPDI). Particular suitability is possessed by the mixture, known as “polymeric MDI” (“crude MDI”), of MDI and more highly condensed analogues having an average functionality of 2 to 4, and also the various isomers of TDI in pure form or as an isomer mixture. As isocyanates for use in the formulation it is preferred to employ those isocyanates or isocyanate mixtures of the kind used as VICG and/or MFI, preferably as VICG and MFI compounds, for producing the composition of the invention. The ratio of siloxanes of the formula (I) to isocyanates in the formulation is preferably from 1:5000 to 1:10, more preferably from 1:1000 to 1:15, very preferably 1:500 to 1:20.

Suitable polyols for use in the formulation are all organic substances having two or more isocyanate-reactive groups, and also preparations thereof. Preferred polyols are all polyether polyols and polyester polyols that are typically used for the production of polyurethane foam materials. Polyether polyols may also be obtained by reaction of polyhydric alcohols or polyfunctional amines with alkylene oxides. Polyester polyols are based preferably on esters of polybasic carboxylic acids (which may be either aliphatic, such as adipic acid, or aromatic, such as phthalic acid or terephthalic acid, for example) with polyhydric alcohols (usually glycols).

A suitable ratio of isocyanate to polyol in the formulation, expressed as the index of the formulation, i.e. as the stoichiometric ratio of isocyanate groups to isocyanate-reactive groups (e.g. OH groups, NH groups) multiplied by 100, is preferably in the range from to 1000, more preferably 80 to 350.

Suitable catalysts for use in the formulation are substances which catalyse the gelling reaction (isocyanate-polyol), the blowing reaction (isocyanate-water) or the di- or trimerization of the isocyanate. Typical examples are the amines triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl) ether, and also metal-containing compounds such as, for example, tin compounds such as dibutyl tin dilaurate or tin(II) 2-ethylhexanoate and potassium salts such as potassium acetate and potassium 2-ethylhexanoate.

Suitable amounts for use are dependent on the type of catalyst and are situated typically in the range from 0.05 to 5 pphp (parts by weight per 100 parts by weight of polyol) or 0.1 to 10 pphp for potassium salts.

Suitable water contents for the formulation are dependent on whether water is or is not being used in addition to the physical blowing agent. It is common to use water quantities of 0.1 to 5 pphp. In the case of foams blown only using water, amounts of up to 35 pphp water may be employed.

In the process of the invention it is also possible to employ different, suitable physical blowing agents. Examples thereof are liquefied CO₂, and volatile liquids, for example hydrocarbons having 4 or 5 carbon atoms, preferably cyclo-, iso- and n-pentane, hydrofluorocarbons, preferably HFC 245fa, HFC 134a and HFC 365mfc, hydrochlorofluorocarbons, preferably HCFC 141b, fluorine-containing olefins, such as hexafluorobutene, chlorotrifluoropropene, tetrafluoropropene, FEA 1100 (DuPont), HBA-1 or HBA-2 (Honeywell), AFA-L1 (Arkema), for example, oxygen-containing compounds such as methyl formate and dimethoxymethane, or hydrochlorocarbons, preferably dichloromethane and 1,2-dichloroethane.

Besides water and the physical blowing agents, it is also possible for other chemical blowing agents to be used that react with isocyanates by evolving gas, such as formic acid, for example.

In the process of the invention there is preference given to using formic acid blowing agent, formic acid derivatives and/or halogen-containing blowing agents.

Suitable flame retardants for use in the formulation employed in the process of the invention are preferably liquid organophosphorus compounds, such as halogen-free organic phosphates, e.g. triethyl phosphate (TEP), halogenated phosphates, e.g. tris(1-chloro-2-propyl) phosphate (TCPP) and tris(2-chloroethyl) phosphate (TCEP) and organic phosphonates, e.g. dimethyl methane phosphonate (DMMP), dimethyl propanephosphonate (DMPP), solids such as ammonium polyphosphate (APP) and red phosphorus, halogenated compounds, examples being halogenated polyols, or solids such as expandable graphite and melamine.

The processing of the formulations of the invention into foam materials in the process of the invention may take place by any of the methods familiar to the skilled person, as for example by hand mixing or, preferably, using high-pressure foaming machines. This may be done using batch processes, for the production, for example, of moulded foams, refrigerators and panels, or continuous processes, in the case, for example, of insulation panels, metal composite elements or slabs, or for spraying processes.

A special case are the 1 and 1.5 component can foams, for which a polyurethane prepolymer is used. In this application as well, the compositions of the invention can be used as foam stabilizers.

The process of the invention affords the polyurethane foam of the invention. The polyurethane foam of the invention may be a rigid polyurethane foam, a flexible polyurethane foam, a viscoelastic foam, an HR foam, a semi-rigid polyurethane foam, a thermoformable polyurethane foam or an integral foam. The term “polyurethane” in this context should be understood as a collective term for a polymer prepared from di- and/or polyisocyanates and polyols or other isocyanate-reactive species, such as amines, for example, where the urethane bond need not be the exclusive or predominant bond type. Polyisocyanurates and polyureas as well are expressly included. The polyurethane foam of the invention is preferably closed-cellular.

A feature of the polyurethane foams of the invention is that they comprise a composition of the invention or have been produced using such a composition. The mass fraction of siloxanes of the formula (I) is preferably from 0.01 to 10 wt %, more preferably from 0.1 to 3 wt %, based on the completed polyurethane foam.

The polyurethane foams of the invention may be used as constituents of or in and/or as refrigerator insulation, insulation panels, sandwich elements, pipe insulations, spray foam, 1 and/or 1.5 component can foam, imitation wood, modelling foam, packaging foam, mattress, furniture cushioning, automotive seat cushioning, headrest, dashboard, automotive interior trim, automotive roof liner, sound absorption material, steering wheel, footwear sole, carpet backing foam, filter foam, sealing foam and adhesive or for producing corresponding products.

The polyurethane foams of the invention are used preferably as insulation material in refrigerator insulation, insulation panels, sandwich elements, pipe insulation systems or spray foam.

Preferred polyurethane foams of the invention and polyurethane foams produced in accordance with the invention are notable for having a lambda value of less than 24, preferably of less than 23 and more preferably of less than or equal to 22 mW/m·K.

Further subject matter and embodiments of the invention will become apparent from the claims, whose disclosure content is, in its full extent, part of the description.

The examples set out below describe the present invention in exemplary form, without any intention that the invention, whose scope is apparent from the entire description and from the claims, should be confined to the embodiments stated in the examples.

### EXAMPLES

### Example 1

### Preparation of Inventive Siloxanes

Inventive siloxanes of the formula (I) may be prepared by the processes known in the prior art, by reaction with corresponding hydrogensiloxanes by means of hydrosilylation. Allyl polyethers and olefins were reacted to give compounds of formula (I). The preparation took place by a process analogous to that from Example 7 of DE 1020070554852 and hence in agreement with the prior art for the production of SiC-linked polyether siloxanes, as also described in EP 1520870, for example. Table 1 summarizes the polyethers used.

TABLE 1
Allyl polyethers used for preparing the compounds in Table 2 (x =
ethylene oxide units, y = propylene oxide units, R″ = end group)

| Polyether | Starter | R″ | x = | y = |
|---|---|---|---|---|
| PE 1 | allyl alcohol | —H | 11 | 0 |
| PE 2 | allyl alcohol | —H | 9 | 3 |
| PE 3 | allyl alcohol | —H | 13 | 4 |
| PE 4 | allyl alcohol | —CH₃ | 12 | 9 |
| PE 5 | allyl alcohol | —H | 15 | 7 |
| PE 6 | allyl alcohol | —H | 13 | 14 |
| PE 7 | allyl alcohol | —CH₃ | 10 | 0 |
| PE 8 | allyl alcohol | —H | 36 | 38 |
| PE 9 | allyl alcohol | —H | 20 | 4.5 |

The structure of the resulting compound of formula (I) can be seen from Table 2. The parameters set out in Table 2 refer to the formula (I) identified above.

TABLE 2
Siloxane intermediates, I 1 to I 19, for the
preparation of the compounds of formula (I)

| Inter | | | | | | | | |
|---|---|---|---|---|---|---|---|---|
| med. | R | Σa | R¹ | R⁴ | Σb | Σc | Σd | R² |
| 1 | CH₃ | 50 | PE 1)¹ | CH₃ | 8 | 0 | <<1 | R¹ |
| 2 | CH₃ | 20 | PE 1 | CH₃ | 2 | 0 | <<1 | R |
| 3 | CH₃ | 40 | PE 7 | CH₃ | 5 | 0 | <<1 | R |
| 4 | CH₃ | 65 | PE 6/PE 8)² | CH₃ | 5 | 0 | <<1 | R¹ |
| 5 | CH₃ | 40 | PE 4/PE 1)³ | CH₃ | 3 | 0.5 | 2 | R¹ |
| 6 | CH₃ | 40 | PE 3 | CH₃ | 3 | 0 | 1 | R |
| 7 | CH₃ | 40 | PE 3 | C₈H₁₇ | 3 | 0.5 | 2 | R¹ |
| 8 | CH₃ | 65 | PE 4/PE 5)³ | CH₃ | 4 | 0 | <<1 | R |
| 9 | CH₃ | 9 | PE 1 | CH₃ | 4 | 0 | 0 | R |
| 10 | CH₃ | 36 | PE 3 | CH₃ | 10 | 0 | 0 | R¹ |
| 11 | CH₃ | 50 | PE 3 | CH₃ | 8 | 0 | <<1 | R |
| 12 | CH₃ | 69 | PE 5 | CH₃ | 5 | | | R |
| 13 | CH₃ | 21.5 | PE 5 | CH₃ | 1.5 | | | R |
| 14 | CH₃ | 33 | PE 2/PE 7)³ | CH₃ | 5 | | | R¹ |
| 15 | CH₃ | 33 | PE 4/PE 5)³ | CH₃ | 5 | | | R¹ |
| 16 | CH₃ | 50 | PE 5 | CH₃ | 8 | 0 | <<1 | R |
| 17 | CH₃ | 36 | PE 5 | CH₃ | 5 | | | R¹ |
| 18 | CH₃ | 63 | PE 5 | CH₃ | 13 | | | R¹ |
| 19 | CH₃ | 55 | PE 9 | CH₃ | 10 | 0 | <<1 | R¹ |

¹Mixture consisting of 80 eq % PE 1 + 20 eq % C16 olefin
²Mixture consisting of 60 wt % PE 6 + 40 eq % PE 8
³Mixture consisting of 50 eq % each of the two PEs

For the preparation of the inventive siloxanes, the structures (intermediates) from Table 2 were reacted with different isocyanates. The reaction took place in accordance with the following process: 30 g each of the siloxane intermediate were admixed with 270 g of isocyanate at 45° C. under a nitrogen atmosphere in a glass flask, and the mixture was stirred for 2 hours. The corresponding results are summarized in Table 3.

TABLE 3
Preparation of the siloxanes of formula I by reaction of the intermediates,
described in Table 2, with different isocyanates.

| Siloxane | Intermediate No. | Isocyanate No. |
|---|---|---|
| 1 | 1 | 1 |
| 2 | 2 | 1 |
| 3 | 3 | 1 |
| 4 | 4 | 1 |
| 5 | 5 | 1 |
| 6 | 6 | 1 |
| 7 | 7 | 1 |
| 8 | 8 | 1 |
| 9 | 9 | 1 |
| 10 | 9 | 2 |
| 11 | 9 | 4 |
| 12 | 10 | 1 |
| 13 | 11 | 1 |
| 14 | 11 | 3 |
| 15 | 12 | 1 |
| 16 | 13 | 1 |
| 17 | 14 | 1 |
| 18 | 15 | 1 |
| 19 | 16 | 1 |
| 20 | 17 | 1 |
| 21 | 18 | 1 |
| 22 | 18 | 2 |
| 23 | 18 | 3 |
| 24 | 18 | 4 |
| 25 | 19 | 1 |

Isocyanates used were as follows:

No. 1: Suprasec® 5025 from Huntsman, a polymeric MDI with an NCO content of 31%.

No. 2: Desmodur® 44V70L from Bayer Material Science, a mixture of diphenylmethane 4,4′-diisocyanate, with isomers and homologs of higher functionality, having an NCO content of 30.5% to 32%.

No. 3: NCO-containing reaction product of Suprasec® 5085 with a polyether prepared starting from butyl, of type “Polyglykol B11/50” from Clariant, with an NCO content of 4.6%.

No. 4: Desmodur® VP 129 from Bayer Material Science, monomeric MDI with increased 2,4-isomer fraction.

### Example 2

### Foaming Examples

For the performance testing of the inventive formulations, the foam formulation employed was as follows:

A: PUR flow formulation

B: PIR insulating panel

C: PIR insulating panel

TABLE 4
Compositions of the formulations for rigid
foam applications, in parts by mass

| Formulation | A | B | C |
|---|---|---|---|
| Polyol 1 | 50 | | |
| Polyol 2 | 50 | | |
| Polyol 3 | | | 15 |
| Polyol 4 | | 100 | |
| Polyol 5 | | | 85 |
| TCPP | — | 15 | 20 |
| PMDETA | | 0.2 | 0.3 |
| DMCHA | 2.0 | — | |
| KOSMOS 75 MEG | — | 4.0 | 3.0 |
| Water | 1.5 | 0.2 | 0.8 |
| HCFO 1233zd | 26 | — | 25 |
| Cyclopentane | — | 8.0 | |
| Formic acid | | 3.0 | |
| Siloxane | 2.0 | 2.0 | 2.0 |
| Desmodur 44V20L | 190 | 200 | 240 |

Poloyols used were as follows:

No. 1: Daltolac® R 471 from Huntsman

No. 2: Voranol® 490 from Dow

No. 3: Polyethylene glycol PR 600 from Clariant

No. 4: Stepanpol® PS 2352 from Stepan

No. 5: Terate® 2541 from Invista

Additives and blowing agents used were as follows:

TCPP: Tris(1-chloro-2-propyl) phosphate

PMDETA: N,N,N′,N″,N″-Pentamethyldiethylenetriamine

DMCHA: N,N-Dimethylcyclohexylamine

KOSMOS 75 MEG: Potassium octoate (75 wt % in ethylene glycol)

HCFO 1233zd: 1-Chloro-3,3,3-Trifluoropropene (E-isomer)

The foaming procedures were carried out by the manual mixing method. For this purpose, the formulations A and B described in Table 4 were processed with different inventive siloxanes by the process of the invention to form corresponding foams. In line with the concentration of 10 wt % used in producing the siloxanes, they were employed as a 10% strength solution in the corresponding isocyanate (see Table 3) and the quantity employed was adapted accordingly in order to introduce the stated amounts of siloxane into the foaming procedure.

For the foaming procedure, all of the components listed in Table 4, apart from siloxane and isocyanate, were weighed out into a beaker and stirred at 1000 rpm for 30 seconds.

Then the isocyanate and the siloxane were added, the reaction mixture was stirred with a 6 cm diameter pan stirrer at 3000 rpm for 5 seconds and immediately transferred to an aluminium mould with a size of 50 cm×25 cm×5 cm which had been thermostatted to 50° C. and lined with polyethylene film. The amount of foam formulation used was determined such that it was 10% above the minimum amount required to fill the mould.

One day after the foaming procedure, the foam materials were analysed. The surfaces on the top and bottom faces, and the internal disruptions after the foams had been cut open, were assessed subjectively on a scale from 1 to 10, where 10 represents an undisrupted foam and 1 a foam with extremely severe disruption. The pore structure (average number of cells per cm) was assessed visually on a cut surface by comparison with reference foams.

The thermal conductivity coefficient was measured on discs 2.5 cm in thickness, using a Hesto Lambda Control instrument, at sample top and bottom face temperatures of 10° C. and 36° C.

### Comparative Examples

Addition of the intermediates from Table 2 to the foaming procedure and to the polyol mixture with blowing agent.

The results are compiled in Table 5. A summary is given of the siloxanes used, the foam formulations, and also of the visual assessment and the pore structure and thermal conductivities of the foams.

TABLE 5
Results of the foaming procedures, part 1

| | Siloxane | | Evaluation | | Lambda |
|---|---|---|---|---|---|
| | from | Foam | top/bottom/ | Cells/ | value/ |
| Ex. | Ex. 1 | formulation | inside | cm | mW/m · K |
| 2.1 | 1 | A | 7/9/8 | 46-50 | 19.7 |
| 2.2 | 2 | B | 8/8/7 | 46-50 | 22.1 |
| 2.3 | 3 | B | 7/9/8 | 46-50 | 22.4 |
| 2.4 | 4 | B | 6/8/9 | 46-50 | 22.6 |
| 2.5 | 5 | B | 7/7/9 | 46-50 | 22.4 |
| 2.6 | 6 | B | 6/7/8 | 41-45 | 22.3 |
| 2.7 | 7 | B | 8/8/7 | 41-45 | 22.6 |
| 2.8 | 8 | B | 8/9/8 | 46-50 | 22.1 |
| 2.9 | 9 | C | 7/9/8 | 46-50 | 20.1 |
| 2.10 | 10 | C | 7/9/8 | 46-50 | 19.9 |
| 2.11 | 11 | C | 7/8/8 | 46-50 | 20.6 |
| 2.12 | 12 | A | 8/8/8 | 41-45 | 20.1 |
| 2.13 | 23 | A | 7/9/8 | 46-50 | 19.8 |
| Comp. 1 | I 10 | A | 6/7/6 | 41-45 | 21.5 |
| Comp. 2 | I 18 | A | 6/6/6 | 41-45 | 21.3 |

Furthermore, foaming operations were performed in which the foam formulations were stored for a period of 6 weeks at 25° C. in order to simulate the times customary in practice that may elapse between the production of the reaction mixtures and their use.

In these cases, as is usual according to the prior art, the siloxane intermediates described in Table 2 were stored in the polyol-containing mixture together with catalysts and blowing agents. The inventive siloxanes were stored in the isocyanate which was subsequently used for the foaming procedure.

Following the storage time, the polyol mixtures and the isocyanate mixtures were again, as described above, stirred with a 6 cm diameter pan stirrer for 5 seconds at 3000 rpm and transferred to an aluminium mould measuring 50 cm×25 cm×5 cm and thermostatted to 50° C.

The results are summarized in Table 6.

TABLE 6
Results of the foaming procedures, part 2

| | Siloxane | | Evaluation | | Lambda |
|---|---|---|---|---|---|
| | from | Foam | top/bottom/ | Cells/ | value/ |
| Ex. | Ex. 1 | formulation | inside | cm | mW/m · K |
| 2.14 | 1 | A | 7/9/8 | 46-50 | 20.9 |
| 2.15 | 2 | B | 8/8/7 | 46-50 | 22.2 |
| 2.16 | 3 | B | 7/9/8 | 46-50 | 22.1 |
| 2.17 | 4 | B | 6/8/9 | 46-50 | 22.6 |
| 2.18 | 5 | B | 7/7/9 | 46-50 | 21.9 |
| 2.19 | 6 | B | 6/7/8 | 41-45 | 21.9 |
| 2.20 | 7 | B | 8/8/7 | 41-45 | 22.1 |
| 2.21 | 8 | B | 8/9/8 | 46-50 | 21.8 |
| 2.22 | 9 | C | 7/9/8 | 46-50 | 20.5 |
| 2.23 | 10 | C | 7/9/8 | 46-50 | 20.3 |
| 2.24 | 11 | C | 8/8/8 | 46-50 | 20.6 |
| 2.25 | 12 | A | 8/7/8 | 41-45 | 20.2 |
| 2.26 | 13 | A | 7/9/8 | 46-50 | 20.0 |
| 2.27 | 14 | B | 8/7/7 | 46-50 | 22.1 |
| 2.28 | 15 | C | 7/7/7 | 46-50 | 20.1 |
| 2.29 | 16 | B | 8/7/8 | 46-50 | 22.3 |
| 2.30 | 17 | C | 8/9/8 | 46-50 | 19.8 |
| 2.31 | 18 | B | 7/9/8 | 46-50 | 22.1 |
| 2.32 | 19 | A | 8/8/7 | 41-45 | 19.9 |
| 2.33 | 20 | A | 8/9/8 | 46-50 | 20.1 |
| 2.34 | 21 | A | 7/8/7 | 46-50 | 20.3 |
| 2.35 | 22 | C | 8/8/8 | 46-50 | 20.7 |
| 2.36 | 23 | A | 8/9/8 | 46-50 | 19.8 |
| 2.37 | 24 | B | 7/8/8 | 41-46 | 22.3 |
| 2.38 | 25 | B | 8/8/8 | 46-50 | 22.0 |
| Comp. 3 | I 10 | A | 2/2/1 | 1-5 | 32.4 |
| Comp. 4 | I 18 | A | 1/1/1 | 1-5 | 33.3 |
| Comp. 5 | I 9 | C | 2/1/1 | 1-5 | 34.5 |
| Comp. 6 | I 14 | C | 1/2/1 | 1-5 | 33.4 |
| Comp. 7 | I 15 | B | 2/2/2 | 1-5 | 32.7 |
| Comp. 8 | I 18 | B | 2/2/2 | 1-5 | 33.9 |

It can be seen that the siloxanes of the invention achieve significant improvements relative to the prior art. Good foam properties are obtained, whereas in the comparative experiments there were observations of massive collapse phenomena and coarsening of the foams, resulting in lambda values that had deteriorated accordingly.

1. A composition comprising a siloxane of formula (I) 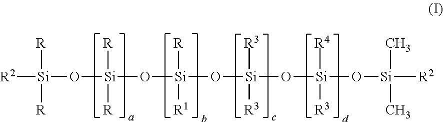
in which
R³= 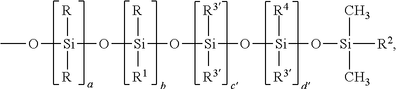
a independently at each occurrence is 0 to 500,
b independently at each occurrence is 0 to 60,
c independently at each occurrence is 0 to 10,
d independently at each occurrence is 0 to 10,
c′ independently at each occurrence is 0 to 10,
d′ independently at each occurrence is 0 to 10,
with the proviso that per molecule of said formula (I) the average number Σd+d′ with R^{3′}═R³ of the T units and the average number Σc+c′ with R^{3′}═R³ of the Q units per molecule is in each case not greater than 50, the average number Σa of the D units per molecule is not greater than 2000 and the average number Σb of the R¹ carrying siloxy units per molecule is not greater than 100,
R independently at each occurrence is at least one radical selected from the group of linear, cyclic or branched, aliphatic or aromatic, saturated or unsaturated hydrocarbon radicals having 1 up to 20 C atoms,
R^{3′} independently at each occurrence is R³ or R,
R² independently at each occurrence is R¹ or R,
R¹ is different from R and independently at each occurrence is at least one of an organic radical and a radical selected from the group consisting of
—CH₂—CH₂—CH₂—O—(CH₂—CH₂O—)ₓ—(CH₂—CH(R′)O—)_{y}—R″
—CH₂—CH₂—O—(CH₂—CH₂O—)ₓ—(CH₂—CH(R′)O—)_{y}—R″
—CH₂—R^{IV}
—CH₂—CH₂—(O)_{x″}—R^{IV}
—CH₂—CH₂—CH₂—O—CH₂—CH(OR″)—CH₂OR″ 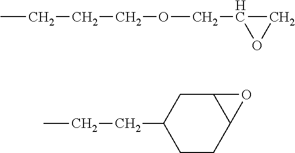
and
—CH₂—CH₂—CH₂—O—CH₂—C(CH₂OR″)₂—CH₂—CH₃,
in which
x is 0 to 100,
x′ is 0 or 1,
y is 0 to 100,
R′ independently at each occurrence is an alkyl or aryl group having 1 to 12 C atoms, and
R″ independently at each occurrence is a hydrogen radical or an alkyl group having 1 to 4 C atoms, a group —C(O)—R′″ with R′″=alkyl radical, a group —CH₂—O—R′, an alkylaryl group, a group —C(O)NH—R′ or a radical of formula (II) 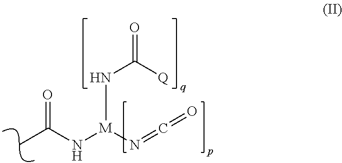
with M=organic radical having at least 5 carbon atoms,
p=0 or 1 to 15,
q=0 or 1 to 15,
p+q is greater than or equal to 1,
Q=organic radical or identical or different radical of said formula (I) attached in turn via the radical R¹, with the proviso that in a compound of said formula (I), irrespective of the number of possible radicals of said formula (I), the number of silicon atoms in the compound is not more than 1500
R^{IV} is a linear, cyclic or branched hydrocarbon radical having 1 to 50 C atoms,
R⁴ independently at each occurrence is R, R¹ and/or a heteroatom-substituted, functionalized, organic, saturated or unsaturated radical selected from the group of alkyl, aryl, chloroalkyl, chloroaryl, fluoroalkyl, cyanoalkyl, acryloyloxyaryl-, acryloyloxyalkyl, methacryloyloxyalkyl, methacryloyloxypropyl and vinyl radical, with the proviso that there is at least one radical of said formula (II) in a compound of said formula (I),
and one or more compounds having two or more isocyanate groups (VICG), wherein the composition comprises no polyols which contain no silicon atom, or reaction products thereof with isocyanates.

2. The composition according to claim 1, wherein said siloxane of said formula (I) comprises a siloxane in which q=0.

3. The composition according to claim 1, wherein said siloxane of said formula (I) comprises a siloxane in which c and d=0.

4. The composition according to claim 1, wherein said siloxane of said formula (I) comprises a siloxane in which the radicals which carry radicals of said formula (II) are arranged exclusively in comb positions.

5. The composition according to claim 1, wherein said siloxane of said formula (I) comprises a siloxane, or consists exclusively of siloxanes, in which the ratio a/b is at least 7.

6. The composition according to claim 1, wherein said siloxane of said formula (I) comprises a siloxane in which oxyalkylene units present in R¹ are exclusively oxyethylene units.

7. The composition according to claim 1, wherein said siloxane of said formula (I) comprises a siloxane in which R¹ independently at each occurrence is an organic radical selected from the group consisting of
—CH₂—CH₂—CH₂—O—(CH₂—CH₂O—)ₓ—(CH₂—CH(R′)O—)_{y}—R″,
—CH₂—CH₂—O—(CH₂—CH₂O—)ₓ—(CH₂—CH(R′)O—)_{y}—R″,
—CH₂—R^{IV}, and any combination thereof,
in which
x is 0 to 100,
y is 0 to 100,
R′ is methyl, and
R″ independently at each occurrence is a group of said formula (II) or an alkyl group having 1 to 4 C atoms, a group —C(O)—R′″ with R′″=alkyl radical, a group —CH₂—O—R′, an alkylaryl group, or the group —C(O)NH—R′, with at least 10 mol % of the radicals R″ being of said formula (II).

8. A process for producing a polyurethane foam, said process comprising:
reacting at least one organic isocyanate having two or more isocyanate functional groups and at least one polyol having two or more isocyanate-reactive groups in the presence of a catalyst and the composition according to claim 1.

9. The process according to claim 8, wherein said reacting further includes a blowing agent, and said blowing agent is selected from one of a formic acid blowing agent a halogen-containing blowing agent.

10. The process according to claim 8, wherein the composition is used in an amount wherein a mass fraction of compounds of said formula (I) in the polyurethane foam is from 0.01 to 10 wt %.

11. A polyurethane foam obtained by a process according to claim 8.

12. The polyurethane foam according to claim 11, wherein the polyurethane foam is closed-cellular.

13. The polyurethane foam according to claim 11, wherein the polyurethane foam is a rigid polyurethane foam, a flexible polyurethane foam, a viscoelastic foam, an HR foam, a semi-rigid polyurethane foam, a thermoformable polyurethane foam or an integral foam.

14. (canceled)
